(19) United States
(12) Patent Application Publication
(10) Pub. No.: US 2017/0116498 A1
(43) Pub. Date: Apr. 27, 2017

(54) COMPUTER DEVICE AND METHOD EXECUTED BY THE COMPUTER DEVICE

(71) Applicant: J TECH SOLUTIONS, INC., Shinjuku-ku, Tokyo (JP)

(72) Inventors: William RAVEANE, Shinjuku-ku, Tokyo (JP); Christopher GREEN, Shinjuku-ku, Tokyo (JP)

(21) Appl. No.: 15/039,855

(22) PCT Filed: Dec. 4, 2013
(86) PCT No.: PCT/JP2013/007125

§ 371 Date: May 27, 2016

(51) Int. Cl. G06K 9/62; G06K 9/00; G06N 3/08

(52) U.S. Cl. CPC G06K 9/6257; G06N 3/08; G06K 9/6203; G06K 9/00986

(57) ABSTRACT

The system is presented to recognize visual inputs through an optimized convolutional neural network deployed on-board the end user mobile device [8] equipped with a visual camera. The system is trained offline with artificially generated data by an offline trainer system [1], and the resulting configuration is distributed wirelessly to the end user mobile device [8] equipped with the corresponding software capable of performing the recognition tasks. Thus, the end user mobile device [8] can recognize what is seen through their camera among a number of previously trained target objects and shapes.

### TECHNICAL FIELD

The present invention relates to a computer device, a method executed by the computer device, a mobile computer device, and a method executed by the mobile computer device, which are capable of executing targeted visual recognition in a mobile computer device.

### BACKGROUND ART

It is well known that computers have difficulty in recognizing visual stimuli appropriately. Compared to their biological counterparts, artificial vision systems lack the resolving power to make sense of the input imagery presented to them. In large part, this is due to variations in viewpoint and illumination, which have a great effect on the numerical representation of the image data as perceived by the system.

Multiple methods have been proposed as plausible solutions to this problem. In particular, convolutional neural networks have proved quite successful at recognizing visual data (for example PTL 1). These are biologically inspired systems based on the natural building blocks of the visual cortex. These systems have alternating layers of simple and complex neurons, extracting incrementally complex directional features while decreasing positional sensitivity as the visual information moves through a hierarchical arrangement of interconnected cells.

The basic functionality of such a biological system can be replicated in a computer device by implementing an artificial neural network. The neurons of this network implement two specific operations imitating the simple and complex neurons found in the visual cortex. This is achieved by means of the convolutional image processing operation for the enhancement and extraction of directional visual stimuli, and specialized subsampling algorithms for dimensionality reduction and positional tolerance increase.

### CITATION LIST

### Patent Literature

PTL 1: Japanese Unexamined Patent Application, Publication No. H06-309457

### SUMMARY OF INVENTION

### Technical Problem

These deep neural networks, due to their computation complexity, have conventionally been implemented in powerful computers where they are able to perform image classification at very high frequency rates. To implement such a system on a low powered mobile computer device, it has traditionally been the norm to submit a captured image to a server computer where the complex computations are carried out, and the result later sent back to the device. While effective, this paradigm introduces time delays, bandwidth overhead, and high loads on a centralized system.

Furthermore, the configuration of these systems depends on large amounts of labeled photographic data for the neural network to learn to distinguish among various image classes through supervised training methods. As this requires the manual collection and categorization of large image repositories, this is often a problematic step involving great amounts of time and effort.

The proposed system aims to solve both of these difficulties by providing an alternative paradigm where the neural network is implemented on board the device itself so that it may carry out the visual recognition task directly and in real time. Additional elements involved in the training and distribution of the neural network are also introduced as part of this system, such as to implement optimized methods that aid in the creation of a high performance visual recognition system.

### Solution to Problem

The computer device of the present invention is characterized in being high-performance as compared to mobile computer devices, in which the computer device includes: a first generating unit for generating artificial training image data to mimic variations found in real images by random manipulations to spatial positioning and illumination of a set of initial 2D images or 3D models; a training unit for training a convolutional neural network with the generated artificial training image data; a second generating unit for generating a configuration file describing an architecture and parameter state of the trained convolutional neural network; and a distributing unit for distributing the configuration file to the mobile computer devices in communication.

The mobile computer device of the present invention is characterized in being low-performance as compared to computer device, in which the mobile computer device includes: a communication unit for receiving a configuration file describing an architecture and parameter state of a convolutional neural network which has been trained off-line by the computer device; a camera for capturing an image of a target object or shape; a processor for running software which analyzes the image with the convolutional neural network; a recognition unit for executing visual recognition of a series of pre-determined shapes or objects based on the image captured by the camera and analyzed through the software running in the processor; and an executing unit for executing a user interaction resulting from the successful visual recognition of the target shape or object.

### Advantageous Effects of Invention

According to the invention, it is possible to provide an alternative paradigm where the neural network is implemented on board the device itself so that it may carry out the visual recognition task directly and in real time.

### BRIEF DESCRIPTION OF DRAWINGS

FIG. 1 is a view showing the various stages involved of the overall presented system.

FIG. 2 is a view showing an example of the artificially generated training data created and used by the system to train the network.

FIG. 3 is a view showing the perspective projection process by which training data is artificially generated.

FIG. 4 is a view showing an exemplary architecture of the convolutional neural network.

FIG. 5 is a view showing the format of the binary configuration file.

FIG. 6 is a view showing the internal process of the client application's main loop as it executes within the mobile device.

FIG. 7 is a view showing the internal structure of a mobile computer device with one or more CPU cores, each equipped with a NEON processing unit.

FIG. 8 is a view showing the internal structure of a mobile computer device equipped with a GPU capable of performing parallel computations.

FIG. 9 is a view showing the relative position and scale of multiple image fragments extracted for individual analysis through the neural network.

FIG. 10 is a view showing the layout of multiple receptor fields in an extracted fragment and the image space over which convolutional operations are performed.

### DESCRIPTION OF EMBODIMENTS

First of all, an overview of a system of the present invention is described.

The system is presented to recognize visual inputs through an optimized convolutional neural network deployed on-board a mobile computer device equipped with a visual camera. The system is trained offline with artificially generated data, and the resulting configuration is distributed wirelessly to mobile devices equipped with the corresponding software capable of performing the recognition tasks. Thus, these devices can recognize what is seen through their camera among a number of previously trained target objects and shapes. The process can be adapted to either 2D or 3D target shapes and objects.

The overview of the system of the present invention is described in further detail below.

The system described herein presents a method of deploying a fully functioning convolutional neural network on board a mobile computer device with the purpose of recognizing visual imagery. The system makes use of the camera hardware present in the device to obtain visual input and displays its results on the device screen. Executing the neural network directly on the device avoids the overhead involved in sending individual images to a remote destination for analysis. However, due to the demanding nature of convolutional neural networks, several optimizations are required in order to obtain real time performance from limited computing capacity found in such devices. These optimizations are briefly outlined in this section.

The system is capable of using the various parallelization features present in the most common processors of mobile computer devices. This involves the execution of a specialized instruction set in the device's CPU or, if available, the GPU. The leveraging of these techniques results in recognition rates that are apt for real time and continuous usage of the system, as frequencies of 5-10 full recognitions per second are easily reached. The importance of such a high frequency is simply to provide a fluid and fast reacting interface to the recognition, so that the user can receive real time feedback on what is seen through the camera.

Given the applications such a mobile system can present, flexibility in the system is essential to distribute new recognition targets to client applications as new opportunities arise. This is approached through two primary parts of the system, its training and its distribution.

The training of the neural network is automated in such a way as to minimize the required effort of collecting sample images by generating artificial training images which mimic the variations found in real images. These images are created by random manipulations to the spatial positioning and illumination of starting images.

Furthermore, neural network updates can be distributed wirelessly directly to the client application without the need of recompiling the software as would normally be necessary for large changes in the architecture of a machine learning system.

Embodiments of the present invention are hereinafter described with reference to the drawings.

The proposed system is based on a convolutional neural network to carry out visual recognition tasks on a mobile computing device. It is composed of two main parts, an offline component to train and configure the convolutional neural network, and a standalone mobile computer device which executes the client application.

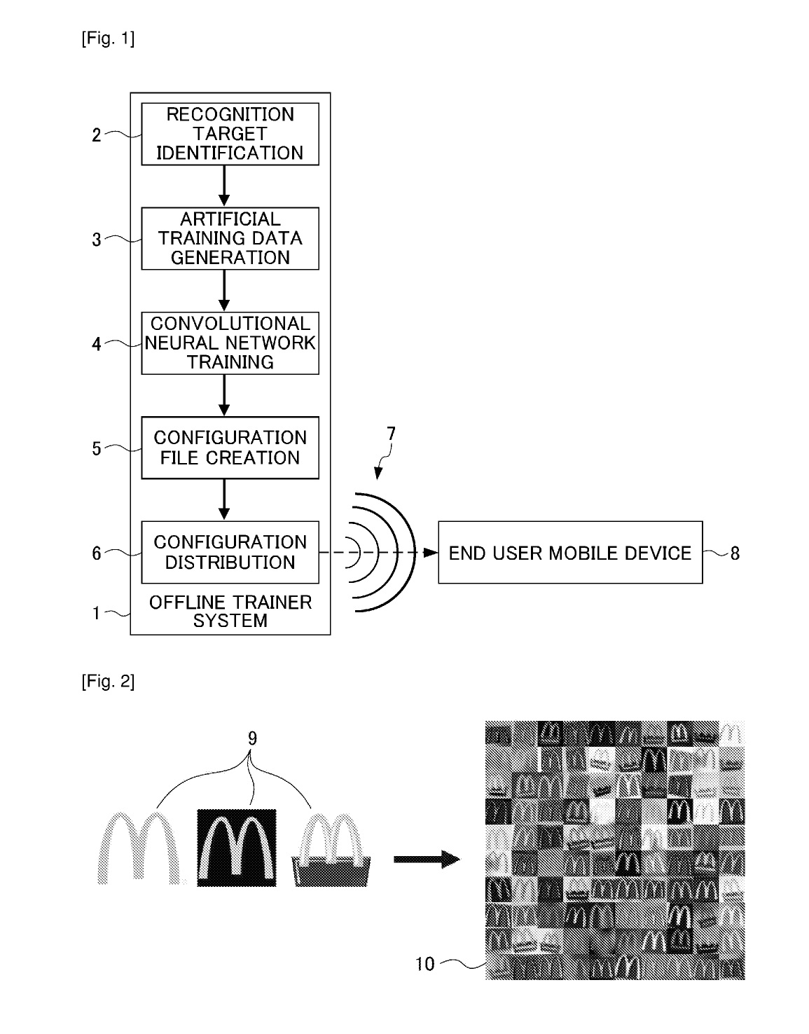

FIG. 1 shows an overview of the system of the present invention, composed of two main parts. The two main parts are composed of: the offline trainer system [1] wherein the recognition mechanism is initially prepared remotely; and the end user mobile device [8] where the recognition task is carried out in real time by the application user.

The final device can be of any form factor such as mobile tablets, smartphones or wearable computers, as long as they fulfill the necessary requirements of (i) a programmable parallel processor, (ii) camera or sensory hardware to capture images from the surroundings, (iii) a digital display to return real time feedback to the user, and (iv) optionally, internet access for system updates.

The offline trainer system [1] manages the training of the neural network runs in several stages. The recognition target identification [2] process admits new target shapes (a set of initial 2D images or 3D models) into the system (offline trainer system [1]) to be later visually recognizable by the device (end user mobile device [8]). The artificial training data generation [3] process generates synthetic training images (training image data) based on the target shape to more efficiently train the neural network. The convolutional neural network training [4] process accomplishes the neural network learning of the target shapes. The configuration file creation [5] process generates a binary data file (a configuration file) which holds the architecture and configuration parameters of the fully trained neural network. The configuration distribution [6] process disseminates the newly learned configuration to any listening end user devices (end user mobile device [8]) through a wireless distribution [7]. The wireless distribution [7] is a method capable of transmitting the configuration details in the binary file to the corresponding client application running within the devices (End user mobile device [8]).

By generating the training data artificially, the system (offline trainer system [1] and end user mobile device [8]) is able to take advantage of an unlimited supply of sample training imagery without the expense of manually collecting and categorizing this data. This process builds a large number of data samples for each recognition target starting from one or more initial seed images or models. Seed images are usually clean copies of the shape or object to be used as a visual recognition target. Through a series of random manipulations, the seed image is transformed iteratively to create variations in space and color. Such a set of synthetic training images can be utilized with supervised training methods to allow the convolutional neural network to find the most optimal configuration state such that it can successfully identify never before seen images which match the shape of the original intended target.

FIG. 2 shows a sample of this artificially generated data. The process starts with three seed images [9], in this case of a commercially exploitable visual target. In other words, three seed images [9] are an example of a set of initial 2D images showing new target shapes that are input in the recognition target identification [2]. A set of 100 generated samples [10] is also displayed, showing the result of the artificial training data generation presented here—although in practice, a much larger number of samples is generated to successfully train the neural network. In other words, a set of 100 generated samples [10] is an example of artificial training image data generated by the artificial training data generation [3].

The data generation process consists of three types of variations—(i) spatial transformations, (ii) clutter addition, and (iii) illumination variations. For 2D target images, spatial transformations are performed by creating a perspective projection of the seed image, which has random translation and rotation values applied to each of its three axes in 3D space, thus allowing a total of six degrees of freedom. The primary purpose of these translations is to expose the neural network, during its training phase, to all possible directions and viewpoints from which the target shape may be viewed by the device at runtime. Therefore, the final trained network will be better equipped to recognize the target shape in a given input image, regardless of the relative orientation between the camera and the target object itself.

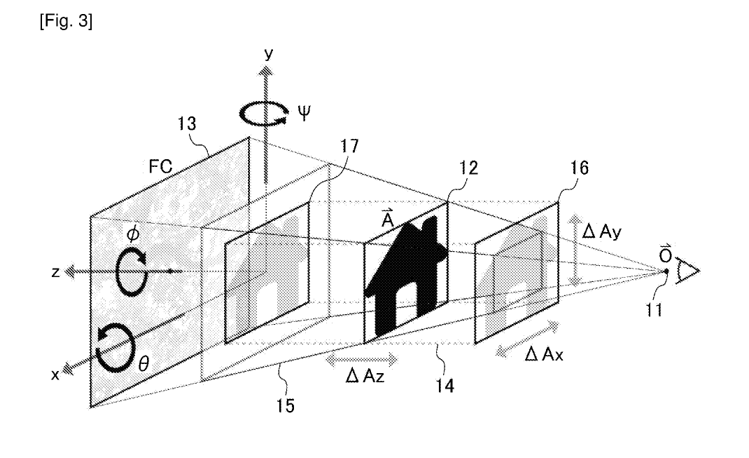

FIG. 3 shows the spatial transformations applied to an initial seed image. A perspective projection matrix based on the pinpoint camera model with the viewpoint [11] positioned at the origin vector O is applied to the seed image [12] whose position is denoted by the vector A, whose components Ax, Ay, Az denote the values for the translation in the x, y and z axes, and the rotations in each of these axes is given by Gamma, Theta, and Phi respectively. These six values are randomized for each new data sample generated. The resulting vector B representation is the standard perspective projection matrix applied to the seed image (vector A), as given by a formula (1).

$$\begin{matrix}[ Math .1 ] & \\ \vec{B} = [ \begin{matrix}1 & 0 & 0 \\ 0 & cos ( θ ) & - sin ( θ ) \\ 0 & sin ( θ ) & cos ( θ )\end{matrix} ] [ \begin{matrix}cos ( γ ) & 0 & sin ( γ ) \\ 0 & 1 & 0 \\ - sin ( γ ) & 0 & cos ( γ )\end{matrix} ] [ \begin{matrix}cos ( ψ ) & - sin ( ψ ) & 0 \\ sin ( ψ ) & cos ( ψ ) & 0 \\ 0 & 0 & 1\end{matrix} ] \vec{A} & ( 1 )\end{matrix}$$

Each of the six variable values are limited to a pre-defined range so as to yield plausible viewpoint variations which allow for correct visual recognition. The exact ranges used will vary on the implementation requirements of the application, but in general, the z-translation limits will be approximately [−30% to +30%] of the distance between the seed image and the viewpoint, the x and y translations will be [−15% to +15%] of the width of the seed image, and the Gamma, Theta, and Phi rotations will be [−30% to +30%] around their corresponding axes. The space outlined within the dashed lines [14] depicts in particular the effect of translation along the z axis (the camera view axis), where the seed image can be seen projected along the viewing frustum [15] at both the near limit [16] and far limit [17] of the z-translation parameter.

Clutter addition is performed at the far clipping plane [13] of the projection, a different texture is placed at this plane for each of the generated sample images. This texture is selected randomly from a large graphical repository. The purpose of this texture is to create synthetic background noise and plausible surrounding context for the target shape, where the randomness of the selected texture allows the neural network to learn to distinguish between the actual traits of the target shape and what is merely clutter noise surrounding the object.

Before rendering the resulting projection, illumination variations are finally applied to the image. These are achieved by varying color information in a similar random fashion as the spatial manipulations. By modifying the image's hue, contrast, brightness and gamma values, simulations can be achieved on the white balance, illumination, exposure and sensitivity, respectively—all of which correspond to variable environmental and camera conditions which usually affect the color balance in a captured image. Therefore, this process allows the network to better learn the shape regardless of the viewing conditions the device may be exposed to during execution.

This process extends likewise to the generation of training data of 3D objects. In this case, the planar seed images previously described are replaced by a digital 3D model representation of the object, and rendered within a virtual environment applying the same translation, rotation and illumination variations previously described. The transformation manipulations, in this case, will result in much larger variations of the projected shape due to the contours of the object. As a result, stricter controls in the random value limits are enforced. Furthermore, the depth information of the rendered training images is also calculated so that it may be used as part of the training data, as the additional information given can be exploited by devices equipped with an RGB-D sensor to better recognize 3D objects.

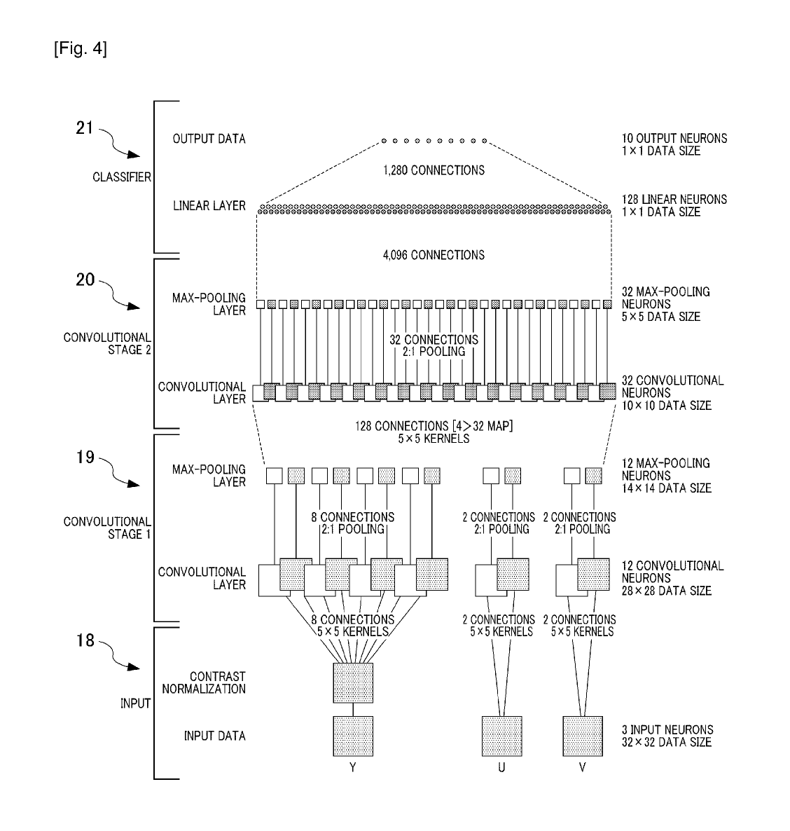

FIG. 4 shows a possible architecture of the convolutional neural networks used by the system. The actual architecture used may vary according to the particular implementation details, and is chosen to better accommodate the required recognition task and the target shapes. However, there are common elements to all possible architectures. The input layer [18] receives the image data in YUV color space (native to most mobile computer device cameras) and prepares it for further analysis through a contrast normalization process. In the case of devices equipped with a depth sensor, the neural network architecture is modified to provide one additional input channel for the depth information, which is then combined to the rest of the network in a manner similar to the U and V color channels. The first convolutional layer [19] extracts a high level set of features through alternating convolutional and max-pooling layers. The second convolutional layer [20] extracts lower level features through a similar set of neurons. The classification layer [21] finally processes the extracted features and classifies them into a set of output neurons corresponding to each of the recognition target classes.

Upon completing the training of the convolutional neural network, a unique set of parameters is generated which describes all of the internal functionality of the network, and embodies all of the information learned by the network to successfully recognize the various image classes it has been trained with. These parameters are stored in a configuration file which can then be directly transmitted to the device (end user mobile device [8]). Distributing the configuration in this manner allows for a simple way of configuring the client application when additional targets are added to the recognition task, without requiring a full software recompile or reinstallation. This not only applies to the individual neuron parameters in the network, but to the entire architecture itself as well, thus allowing great flexibility for changes in network structure as demands for the system change.

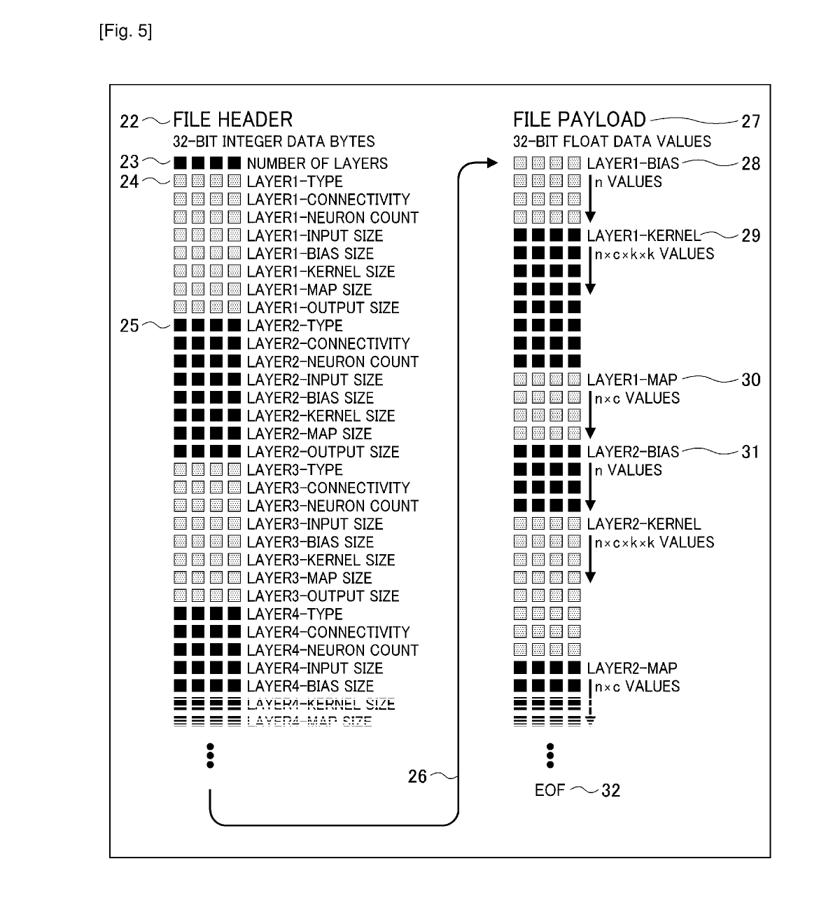

FIG. 5 depicts the packing specification of the convolutional neural network configuration file. The configuration is packed as binary values in a variable sized data file composed of a header and payload. The file header [22] section is the portion of the file containing the pertaining metadata that specifies the overall architecture of the convolutional neural network. It is composed entirely of 32-bit signed integer values (4-byte words). The first value in the header is the number of layers [23], which specifies the layer count for the entire network. The data file is followed by a series of layer header blocks [24] for each of the layers of the network in sequence. Each block specifies particular attributes for the corresponding layer in the network, including the type, connectivity, neuron count, input size, bias size, kernel size, mapsize, and expected output size of the neuron. For each additional layer in the network, additional layer header blocks [25] are sequentially appended to the data file. Upon reaching the end of the header block [26], the file payload [27] immediately begins. This section is composed entirely of 32-bit float values (4-byte words). Similarly, this is composed of sequential blocks for each of the layers in the network. For every layer, three payload blocks are given. The first block is the layer biases [28], which contains the bias offsets for each of the neurons in the current layer, a total of n values is given in this block, where n is the number of neurons in the layer. Next is the layer kernels [29] block, which contains the kernel weights for each of the connections between the current layer neurons and the previous layer. There is a total of n*c*k*k values, where c is the number of connected neurons in the previous layer and k is the kernel size. Finally, a block with the layer map [30] is given, which contains the interconnectivity information between neuron layers. There is a total of n*c values in this block. After the first layer's payload, the remaining layer payload blocks [31] are sequentially appended to the file following the same format until the EOF [32] is reached. A typical convolutional neural network will contain 100,000 such parameters, thus the typical filesize for a binary configuration file is 400 kilobytes.

This configuration file is distributed wirelessly over the internet to the corresponding client application deployed on the end users' devices (end user mobile device [8]). When the device receives (end user mobile device [8]) the configuration file, it replaces its previous copy, and all visual recognition tasks are then performed using the new version. After this update, execution of the recognition task is fully autonomous and no further contact with the remote distribution system (offline trainer system [1]) is required by the device (end user mobile device [8]), unless a new update is broadcasted at a later time.

The offline trainer system [1] according to an embodiment of the present invention has been described above with reference to FIGS. 1 to 5.

The computer device of the present invention is not limited to the present embodiment; and modification, improvement and the like within a scope that can achieve the object of the invention are included in the present.

For example, the computer device of the present invention is characterized in being high-performance as compared to mobile computer devices, in which the computer device includes: a first generating unit for generating artificial training image data to mimic variations found in real images by random manipulations to spatial positioning and illumination of a set of initial 2D images or 3D models; a training unit for training a convolutional neural network with the generated artificial training image data; a second generating unit for generating a configuration file describing an architecture and parameter state of the trained convolutional neural network; and a distributing unit for distributing the configuration file to the mobile computer devices in communication.

In the computer device of the present invention, the first generating unit: executes randomly selected manipulations of spatial transformations of the initial 2D images or 3D object; implements synthetic clutter addition with randomly selected texture backgrounds; applies randomly selected illumination variations to simulate camera and environmental viewing conditions; and generates the artificial training image data as a result.

In the computer device of the present invention, the second generating unit: stores the architecture of the convolutional neural network into a file header; stores the parameters of the convolutional neural network into a file payload; packs the data including the file header and the file payload in a manner appropriate for direct sequential reading during runtime, appropriate for the use in optimized parallel processing algorithms; and generates the configuration file as a result.

Next, the end user mobile device [8] according to an embodiment of the present invention is described with reference to FIGS. 7 to 10.

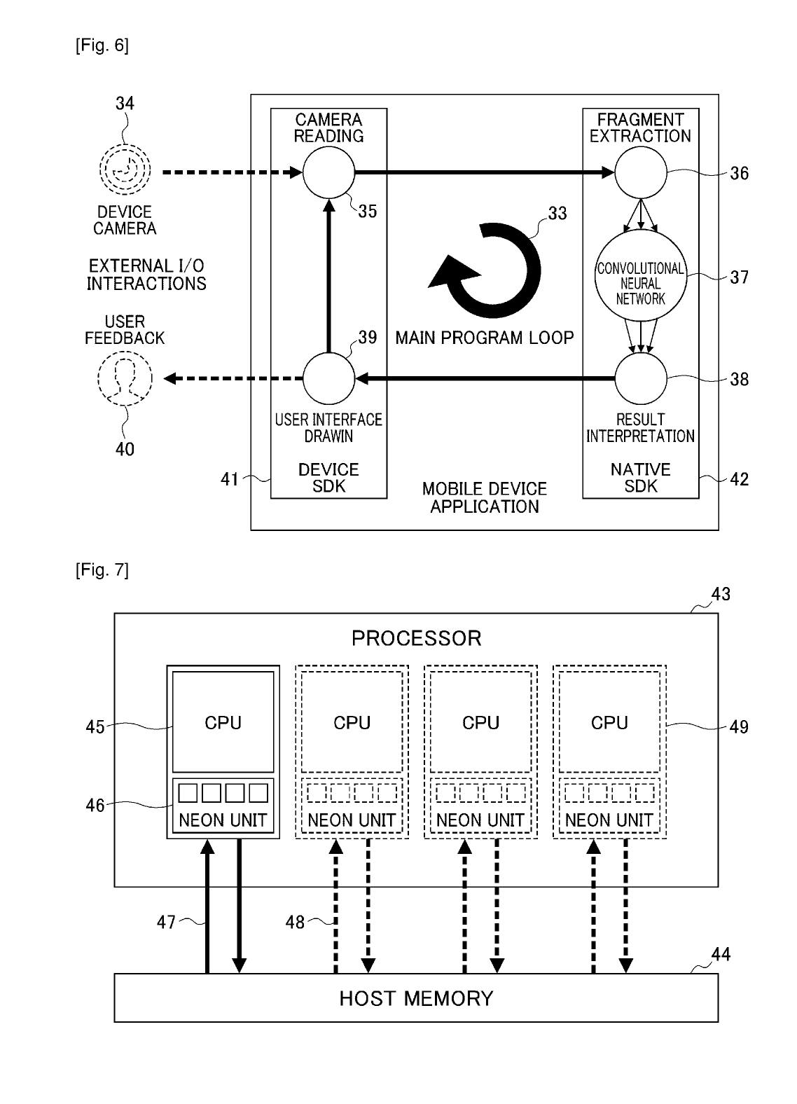

FIG. 6 shows the full image recognition process that runs inside the client application within the mobile computer device (end user mobile device [8]). The main program loop [33] runs continuously, analyzing at each iteration an image received from the device camera [34] and providing user feedback [40] in real time. The process starts with the camera reading [35] step, where a raw image is read from the camera hardware. This image data is passed to the fragment extraction [36] procedure, where the picture is subdivided into smaller pieces to be individually analyzed. The convolutional neural network [37] then processes each of these fragments, producing a probability distribution for each fragment over the various target classes the network has been designed to recognize. These probability distributions are collapsed in the result interpretation [38] step, thereby establishing a singular outcome for the full processed image. This result is finally transported to the user interface drawing [39] procedure, where it is visually depicted in any form that may be of benefit to the final process and end user. Execution control is next passed to the camera reading [35] step once again, wherein a new iteration of the loop begins.

A distinction is made on which processes run on each section of the device platform. Those processes requiring interaction with peripheral hardware found in the device, such as the camera and display, run atop the device SDK [41]—a framework of programmable instructions provided by the different vendors of each mobile computer device platform. On the other hand, processes which are mathematically intensive, hence requiring more computational power, are programmed through the native SDK [42]—a series of frameworks of low-level instructions provided by the manufacturers of different processor architectures, which are designed to allow direct access to the device's CPU, GPU and memory, thus allowing it to take advantage of specialized programming techniques.

The system is preferably implemented in a mobile computer device (end user mobile device [8]) with parallelized processing capabilities. The most demanding task in the client application is the convolutional neural network, which is a highly iterative algorithm that can achieve substantial improvements in performance by being executed in parallel using an appropriate instruction set. The two most common parallel-capable architectures found in mobile computer devices are supported by the recognition system.

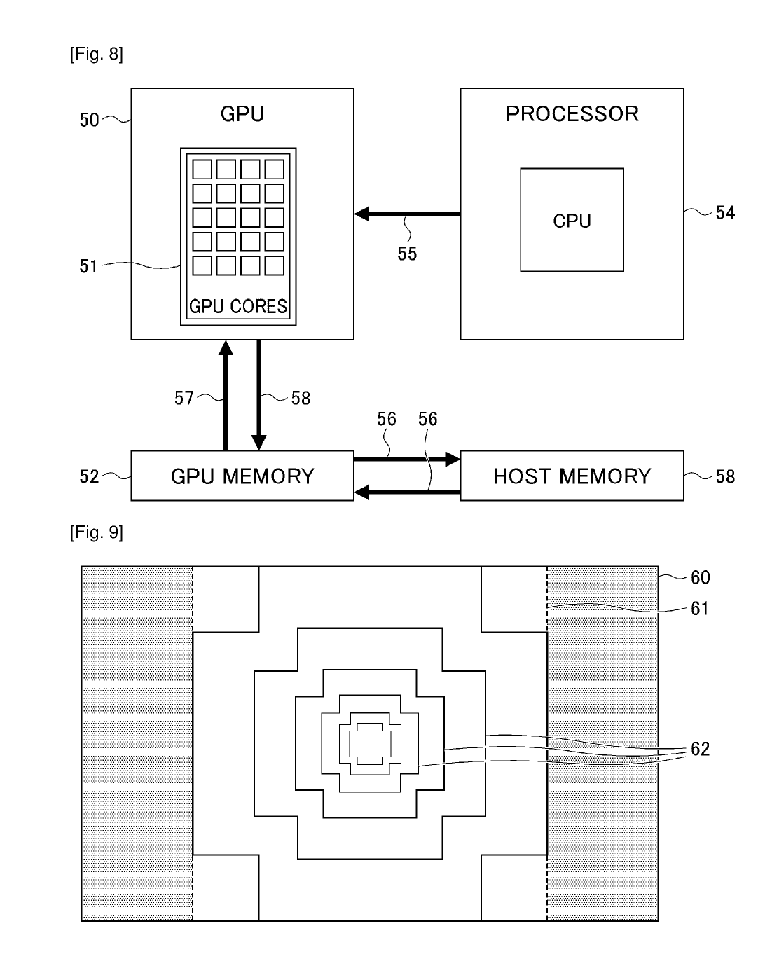

FIGS. 7 and 8 each show an example of a Diagram of a Parallelized CPU Architecture for the end user mobile device [8].

FIG. 7 depicts a parallel CPU architecture based on the NEON/Advanced-SIMD extension of an ARM-based processor [43]. Data from the device's memory [44] is read [47] by each CPU [45]. The NEON unit [46] is then capable of processing a common instruction on 4, 8, 16, or 32 floating-point data registers simultaneously. This data is then written [48] into memory. Additional CPUs [49] as found in a multi-core computer device can benefit the system by providing further parallelization capability through more simultaneous operations.

FIG. 8 illustrates the architecture of a mobile computer device equipped with a parallel capable GPU [50], such as in the CUDA processor architecture, composed of a large number of GPU cores [51], each capable of executing a common instruction set [55] provided by the device's CPU [54]. As before, data is read [56] from host memory [53]. This data is copied into GPU memory [52], a fast access memory controller specialized for parallel access. Each of the GPU cores [51] is then able to quickly read [57] and write [58] data to and from this controller. The data is ultimately written [59] back to Host Memory, from where it can be accessed by the rest of the application. This is exemplary of the CUDA parallel processing architecture, which is implemented in GPUs capable of processing several hundred floating-point operations simultaneously through its multiple cores. However, this is not limited to CUDA architectures, as there exists other configurations which the system can also make use of, such as any mobile SoC with a GPU capable of using the OpenCL parallel computing framework.

These highly optimized parallel architectures display the importance of data structure in the configuration file. This binary data file represents an exact copy of the working memory used by the client application. This file is read by the application and copied directly to host memory and, if available, GPU memory. Therefore, the exact sequence of blocks and values stored in this data file is of vital importance, as the sequential nature of the payload allows for optimized and coalesced data access during the calculation of individual convolutional neurons and linear classifier layers, both of which are optimized for parallel execution. Such coalesced data block arrangements allow for a non-strided sequential data reading pattern, forming an essential optimization of the parallelized algorithms used by the system when the network is computed either in the device CPU or in the GPU.

FIG. 9 displays the multiple fragments extracted at various scales from a full image frame [60] captured by the device camera. The usable image area [61] is the central square portion of the frame, as the neural network is capable of processing only regions with equal width and height. Multiple fragments [62] are extracted at different sizes, all in concentric patterns towards the center of the frame, forming a pyramid structure of up to ten sequential scales, depending on the camera resolution and available computing power. As the mobile device is free to be pointed towards any object of interest by the device user, it is not entirely necessary to analyze every possible position in the image frame as is traditionally done in offline visual recognition—rather, only different scales are inspected to account for the variable distance between the object and the device. By providing a fast response time, this approach allows for quick aiming corrections to be made by the user, should the target object not be framed correctly at first.

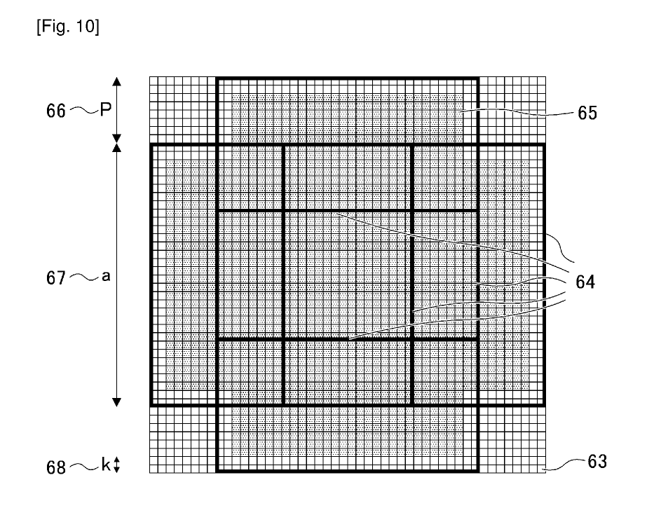

FIG. 10 shows a detail of the extracted fragments over the image pixel space [63]. Five individual receptor fields [64], all of identical width and height [67], overlap each other with a small horizontal and vertical offset [66] forming a cross pattern. Each of these receptor fields is then processed by the convolutional neural network. Thus, a total of five convolutional neural network executions are performed for each of these receptor field patterns. The convolutional space [65] represents the pixels over which the convolution operation of the first feature extraction stage in the network is actually performed. A gap [68] is visible between the analyzed input space and the convolved space, due to the kernel padding introduced by this operation. As can be observed, a large amount of convolved pixels are shared among the five network passes over the individual receptor fields [64]. This property of the pattern is fully exploited by the system, by computing the multiple convolutions over the entire convolutional space [65] once, and re-utilizing the results for each of the five executions. In the particular setup depicted, a performance ratio of 3920:1680 (approximately 2.3×) can be achieved by using this approach. When the pattern offset [66] is chosen correctly, such as to match (or be a multiple of) the layer's max-pooling size, this property holds true for the second convolutional stage as well, and further optimization can be achieved by pre-caching the convolutional space for that layer as well.

After fully analyzing an image frame as captured by the device camera, the convolutional neural network will have executed up to 50 times (ten sequential fragments [62], with five individual receptor fields [64] each). Each execution returns a probability distribution over the recognition classes. These 500 distributions are collapsed with a statistical procedure to produce a final result which will have an estimate of which shape (if any) was found to match in the input image, and roughly at which of the scales it was found to fit best. This information is ultimately displayed to the user, by any implementation-specific means that may be programmed in the client application—such as displaying a visual overlay over the position of the recognized object, showing contextual information from auxiliary hardware like a GPS sensor, or opening an internet resource related to the recognized target object.

The end user mobile device [8] according to an embodiment of the present invention has been described above with reference to FIGS. 7 to 10.

The mobile computer device of the present invention is not limited to the present embodiment; and modification, improvement and the like within a scope that can achieve the object of the invention are included in the present.

For example, the mobile computer device of the present invention is characterized in being low-performance as compared to computer device, in which the mobile computer device includes: a communication unit for receiving a configuration file describing an architecture and parameter state of a convolutional neural network which has been trained off-line by the computer device; a camera for capturing an image of a target object or shape; a processor for running software which analyzes the image with the convolutional neural network; a recognition unit for executing visual recognition of a series of pre-determined shapes or objects based on the image captured by the camera and analyzed through the software running in the processor; and an executing unit for executing a user interaction resulting from the successful visual recognition of the target shape or object.

In the mobile computer device of the present invention, the recognition unit: extracts multiple fragments to be analyzed individually, from the image captured by the camera; analyzes each of the extracted fragments with the convolutional neural network; and executes the visual recognition with a statistical method to collapse the results of multiple convolutional neural networks executed over each of the fragments.

In the mobile computer device of the present invention, when the multiple fragments are extracted, the recognition unit: divides the image captured by the camera into concentric regions at incrementally smaller scales; overlaps individual receptive fields at each the extracted fragments to analyze with the convolutional neural network; and caches convolutional operations performed over overlapping pixels of the convolutional space in the individual receptive fields.

The mobile computer device of the present invention further includes a display unit and auxiliary hardware, in which the user interaction includes: displaying a visual cue in the display unit, overlaid on top of an original image stream captured from the camera, showing detected position and size where the target object was found; using the auxiliary hardware to provide contextual information related to the recognized target object; and launching internet resources related to the recognized target object.

### REFERENCE SIGNS LIST

1 Offline Trainer System—The system that runs remotely to generate the appropriate neural network configuration for the given recognition targets
2 Recognition Target Identification—The process by which the target shapes are identified and admitted into the system
3 Artificial Training Data Generation—The process by which synthetic data is generated for the purpose of training the neural network
4 Convolutional Neural Network Training—The process by which the neural network is trained for the generated training data and target classes
5 Configuration File Creation—The process by which the binary configuration file is created and packed
6 Configuration Distribution—The process by which the configuration file and any additional information is distributed to listening mobile devices
7 Wireless Distribution—The method of distribution the configuration file wirelessly to the end user devices
8 End User Mobile Device—The end device running the required software to carry out the recognition tasks
9 Seed Images—Three sample seed images of a commercially exploitable recognition target
10 Generated Samples—A small subset of the artificially generated data created from seed images, consisting of 100 different training samples
11 Viewpoint—The viewpoint of the perspective projection
12 Seed Image—The starting position of the seed image
13 Far Clipping Plane—The far clipping plane of the perspective projection, where the background clutter texture is positioned
14 Z Volume—The volume traced by the translation of the seed image along the Z axis
15 Viewing Frustum—The pyramid shape formed by the viewing frame at the viewpoint
16 Near Limit—The projection at the near limit of the translation in the z-axis
17 Far Limit—The projection at the far limit of the translation in the z-axis
18 Input Layer—The input and normalization neurons for the neural network
19 First Convolutional Layer—The first feature extraction stage of the network
20 Second Convolutional Layer—The second feature extraction stage of the network
21 Classification Layer—The linear classifier and output neurons of the neural network
22 File Header—The portion of the file containing the pertaining metadata that specifies the overall architecture of the convolutional neural network
23 total number of layers in the network
24 Layer Header Block—A block of binary words that specify particular attributes for the first layer in the network
25 Additional Layer Header Blocks—Additional blocks sequentially appended for each additional layer in the network
26 End Of Header Block—Upon completion of each of the header blocks, the payload data is immediately appended to the file at the current position
27 File Payload—The portion of the file containing the configuration parameters for each neuron and connection in each individual layer of the network
28 Layer Biases—A block of binary words containing the bias offsets for each neuron in the layer
29 Layer Kernels—A block of binary words containing the kernels for each interconnected convolutional neuron in the network
30 Layer Map—A block of binary words that describes the connection mapping between consecutive layers in the network
31 Additional Layer Payload Blocks—Additional blocks sequentially appended for each additional layer in the network
32 End Of File—The end of the configuration file, reached after having appended all configuration payload blocks for each of the layers in the network
33 Main Program Loop—Directionality of the flow of information in the application's main program loop
34 Device Camera—The mobile computer device camera
35 Camera Reading—The processing step that reads raw image data from the device camera
36 Fragment Extraction—The processing step that extracts fragments of interest from the raw image data
37 Convolutional Neural Network—The processing step that analyzes each of the extracted image fragments in search of a possible recognition match
38 Result Interpretation—The processing step that integrates into a singular outcome the multiple results obtained by analyzing the various fragments
39 User Interface Drawing—The processing step that draws into the application's user interface the final outcome from the current program loop
40 User Feedback—The end user obtains continuous and real-time information from the recognition process by interacting with the application's interface
41 Device SDK—The computing division running within the high level device SDK as provided by the device vendor
42 Native SDK—The computing division running within the low level native SDK as provided by the device's processor vendor
43 Processor—The processor of the mobile computer device
44 Memory—The memory controller of the mobile computer device
45 CPU—A Central Processing Unit capable of executing general instructions
46 NEON Unit—A NEON Processing Unit capable of executing four floating point instructions in parallel
47 Memory Reading—The procedure by which data to be processed is read from memory by the CPU
48 Memory Writing—The procedure by which data is written back into memory after being processed by the CPU
49 Additional CPUs—Additional CPUs that may be available in a multi-core computer device
50 GPU—The graphics processing unit of the device
51 GPU Cores—The parallel processing cores capable of execute multiple floating point operations in parallel
52 GPU Memory—A fast access memory controller specially suited for GPU operations
53 Host Memory—The main memory controller of the device
54 GP CPU—The central processing unit of the device
55 GPU Instruction Set—The instruction set to be executed in the GPU as provided by the CPU
56 Host Memory Reading—The procedure by which data to be processed is read from the host memory and copied to the GPU memory
57 GPU Memory Reading—The procedure by which data to be processed is read from the GPU memory by the GPU
58 GPU Memory Writing—The procedure by which data is written back into GPU memory after being processed by the GPU
59 Host Memory Writing—The procedure by which processed data is copied back into the Host memory to be used by the rest of the application
60 Full Image Frame—The entire frame as captured by the device camera
61 Usable Image Area—The area of the image over which recognition takes place
62 Fragments—Smaller regions of the image, at multiple scales, each of which is analyzed by the neural network
63 Image Pixel Space—The input image pixels, drawn for scale reference
64 Individual Receptor Field—Each of five overlapping receptor fields—a small fragment taken from the input image which is directly processed by a convolutional neural network
65 Convolutional Space—The pixels to which the convolutional operations are applied to
66 Receptor Field Stride—The size of the offset in the placement of the adjacent overlapping receptor fields
67 Receptor Field Size—The length (and width) of an individual receptor field
68 Kernel Padding—The difference between the area covered by the receptor fields and the space which is actually convolved, due to the padding inserted by the convolution kernels

1. A computer device which is high-performance as compared to mobile computer devices, the computer device comprising:
a first generating unit for generating artificial training image data to mimic variations found in real images, by random manipulations to spatial positioning and illumination of a set of initial 2D images or 3D models;
a training unit for training a convolutional neural network with the generated artificial training image data;
a second generating unit for generating a configuration file describing an architecture and parameter state of the trained convolutional neural network;
and
a distributing unit for distributing the configuration file to the mobile computer devices in communication.

2. The computer device according to claim 1, wherein
the first generating unit:
executes randomly selected manipulations of spatial transformations of the initial 2D images or 3D object;
implements synthetic clutter addition with randomly selected texture backgrounds;
applies randomly selected illumination variations to simulate camera and environmental viewing conditions;
and
generates the artificial training image data as a result.

3. The computer device according to claim 1, wherein
the second generating unit:
stores the architecture of the convolutional neural network into a file header;
stores the parameters of the convolutional neural network into a file payload;
packs the data including the file header and the file payload in a manner appropriate for direct sequential reading during runtime, appropriate for the use in optimized parallel processing algorithms;
and
generates the configuration file as a result.

4. A method of executed by a computer which is higher-performance as compared to mobile computer devices, the method comprising:
a first generating step of generating artificial training image data to mimic variations found in real images, by random manipulations to spatial positioning and illumination of a set of initial 2D images or 3D models;
a training step of training a convolutional neural network with the generated artificial training image data;
a second generating step of generating a configuration file describing an architecture and parameter state of the trained convolutional neural network;
and
a distributing step of distributing the configuration file to the mobile computer devices in communication.

5. A mobile computer device which is low-performance as compared to computer device, the mobile computer device comprising:
a communication unit for receiving a configuration file describing an architecture and parameter state of a convolutional neural network which has been trained off-line by the computer device;
a camera for capturing an image of a target object or shape;
a processor for running software which analyzes the image with the convolutional neural network;
a recognition unit for executing visual recognition of a series of pre-determined shapes or objects based on the image captured by the camera and analyzed through the software running in the processor;
and
an executing unit for executing a user interaction resulting from the successful visual recognition of the target shape or object.

6. The mobile computer device according to claim 5, wherein
the recognition unit:
extracts multiple fragments to be analyzed individually, from the image captured by the camera;
analyzes each of the extracted fragments with the convolutional neural network;
and
executes the visual recognition with a statistical method to collapse the results of multiple convolutional neural networks executed over each of the fragments.

7. The mobile computer device according to claim 6, wherein, when the multiple fragments are extracted, the recognition unit:
divides the image captured by the camera into concentric regions at incrementally smaller scales;
overlaps individual receptive fields at each the extracted fragments to analyze with the convolutional neural network;
and
caches convolutional operations performed over overlapping pixel of convolutional space in the individual receptive fields.

8. The mobile computer device according to claim 5,
further comprising: a display unit and auxiliary hardware;
displaying a visual cue in the display unit, overlaid on top of an original image stream captured from the camera, showing detected position and size where the target object was found;
using the auxiliary hardware to provide contextual information related to the recognized target object;
and
launching internet resources related to the recognized target object.

9. A method executed by a mobile computer device which is low-performance as compared to computer device,
the mobile computer device including:
a communication unit for receiving a configuration file describing an architecture and parameter state of a convolutional neural network which has been trained off-line by the computer device;
a camera for capturing an image of the target object or shape;
a processor for running software which analyzes the image with the convolutional neural network;
the method comprising:
a recognition step of executing the visual recognition of a series of pre-determined shapes or objects based on the image captured by the camera and analyzed through the software running in the processor;
and
an executing step of executing a user interaction resulting from the successful visual recognition of the target shape or object.
